(19) United States
(12) Patent Application Publication
(10) Pub. No.: US 2008/0023398 A1
(43) Pub. Date: Jan. 31, 2008

(54) Method for removal and recovery of water from polymer manufacturing

(75) Inventors: Nicholas G. Borisow, Hatboro, PA (US); David M. Polizzotti, Yardley, PA (US); Paul D. Mayovich, Somerdale, NJ (US); Tri Q. Huynh, La Mesa, CA (US)

Correspondence Address: WEGMAN, HESSLER & VANDERBURG, 6055 ROCKSIDE WOODS BOULEVARD, SUITE 200, CLEVELAND, OH, 44131, US

(73) Assignee: General Electric Company, Schenectady, NY (US)

(21) Appl. No.: 11/494,937

(22) Filed: Jul. 28, 2006

(51) Int. Cl. B01D 61/00

(52) U.S. Cl. 210/638; 210/650; 585/818

(57) ABSTRACT

A method for purifying and recovering wash water in a polymer manufacturing process using media filtration with reverse osmosis membranes to achieve separation and water reuse. Wash water containing particles of polymer product and surfactants is introduced into a media filtration unit having filter media particles which comprise a substrate and an adsorbed layer of a coagulant compound adsorbed onto the substrate. The filtrate stream is then introduced to a staged reverse osmosis (RO) system. The RO system concentrates the surfactants in a rejects stream to a desired concentration, and the rejects stream is preferably disposed of after reaching the desired concentration, while the permeate is preferably reused.

### BACKGROUND OF THE INVENTION

1. Field of the Invention

The present invention relates generally to the processing of a wastewater, and more specifically to the removal of particulate residues from a polymer manufacturing process thereby enabling membrane technology to concentrate waste for removal/disposal and allowing permeate to be reused in the process.

2. Description of Related Art

Polymeric materials are commonly manufactured using a plurality of methods. Exemplary of the polymer manufacturing process is the manufacture of plastics (e.g., thermosetting resins, thermoplastic resins, polymer resins, (e.g., polyethers, polyethylene, polyvinyl) (e.g., polyvinyldifluoride)), oil soluble or modified resins). In many instances of polymer manufacturing, the polymer may be washed (as with de-ionized water), thereby generating a stream of wastewater. The wastewater often contains small particles of polymer product and other chemicals introduced or created during polymerization that must be removed before the wastewater can be reused, discharged to the sewer system or otherwise disposed of as required by environmental regulations or process flow requirements.

One method for treating this waste stream is to use carbon absorption. However, carbon adsorption does little to reduce the total volume of wastewater. On the other hand, membrane processes have the advantage of being able to separate the waste stream into a concentrated fraction containing wastes (e.g., surfactants) for subsequent reuse or destruction and a permeate stream which provides an opportunity for water recovery and reuse in the plant. The re-use potential makes the use of membranes economically attractive. However, the membrane option is subject to the ability to remove particulate matter from the influent wastewater as these particles will quickly plug the membranes and compromise their performance.

Prefiltration of the wastewater to remove the particulate matter has been difficult due to the significant solids concentration and to the small particle sizes of the contaminants which range from ˜0.1 to ˜2.2 microns. Traditional and simple filtration methods are typically not effective. For example, 0.45-0.50 μm cartridge filters give good results in terms of solid removal, but these filters become plugged almost immediately and require frequent backwashing and replacement. Larger 1-2 μm cartridge filters provide acceptable regeneration frequencies but give poor results in terms of solid removal (i.e., only 40-60%). Also, traditional multi media filtration methods are not acceptable for removing particulates as the particle sizes are to small to be efficiently captured and removed. Finally, it is noted that using membranes to remove the solids in the waste stream is not viable because the solids will foul the membrane and often surfactants contained in the waste stream adsorb onto the membrane and further compromise membrane efficacy.

Therefore there is a need to have an efficient treatment method that will provide significant concentration of solids without removal of other dissolved materials (e.g., surfactants) so that membrane processes will be able to concentrate the filtered waste without fouling. Processing the waste via membranes will help defray system costs and meet environmental objectives.

### SUMMARY OF THE INVENTION

The invention allows removal of polymerization solid from a waste stream without substantially altering or removing dissolved moieties (e.g., surfactants, conditioners or the like) in the wastewater so that membrane technologies are able to separate the resultant waste stream into a concentrate containing high concentrations of waste (e.g., surfactant), and permeate water which can be reused in the process. The invention is a unique method directed to purifying and recovering wastewater created during polymer manufacturing using a media filtration method that does not remove soluble components of the waste. This filtration method is followed by a plurality of reverse osmosis membranes to achieve concentration of the waste, and production of a permeate flow that can be used for water reuse. The method includes providing a specialized media filtration unit having filter media particles which comprise a polymer coated substrate and an adsorbed layer of a polymer.

The method also includes introducing an input of wastewater containing particles and dissolved materials (e.g., surfactants) into the media filtration unit so that substantially all of the particulate matter are removed by the media filtration unit and substantially all of the soluble components, or all of a desired component, of the waste stream remains in the effluent of the media filtration unit. Advantageously, the volume of the stream is not diminished. The effluent from the media filter is then introduced to a plurality of membrane filtrations units, e.g., reverse osmosis (RO) units, to split the stream into a concentrated reject stream and a permeate stream. The method includes collecting the permeate from all stages of the RO system for reuse, and using the reject stream of one RO unit as the feed stream to a subsequent RO unit. Alternatively, this process could be run in batch mode in which case the effluent from one RO system may be stored in a tank for subsequent processing or disposal. Ultimately, when the reject stream has been sufficiently concentrated, it is collected for disposal.

The present invention and its advantages over the prior art will become apparent upon reading the following detailed description and the appended claims with reference to the accompanying drawings.

### BRIEF DESCRIPTION OF THE DRAWINGS

The above mentioned and other features of this invention will become more apparent and the invention itself will be better understood by reference to the following description of embodiments of the invention taken in conjunction with the accompanying drawings, wherein:

FIG. 1 illustrates a schematic diagram of a system for removal of polymer residues from a wastewater stream in accordance with the invention; and

FIG. 2 illustrates the media particles that may be used in the first stage of the overall separation process shown in FIG. 1.

### DETAILED DESCRIPTION OF THE INVENTION

The invention will now be described in the following detailed description with reference to the drawings, wherein preferred embodiments are described in detail to enable practice of the invention. Although the invention is described with reference to these specific preferred embodiments, it will be understood that the invention is not limited to these preferred embodiments. But to the contrary, the invention includes numerous alternatives, modifications and equivalents as will become apparent from consideration of the following detailed description.

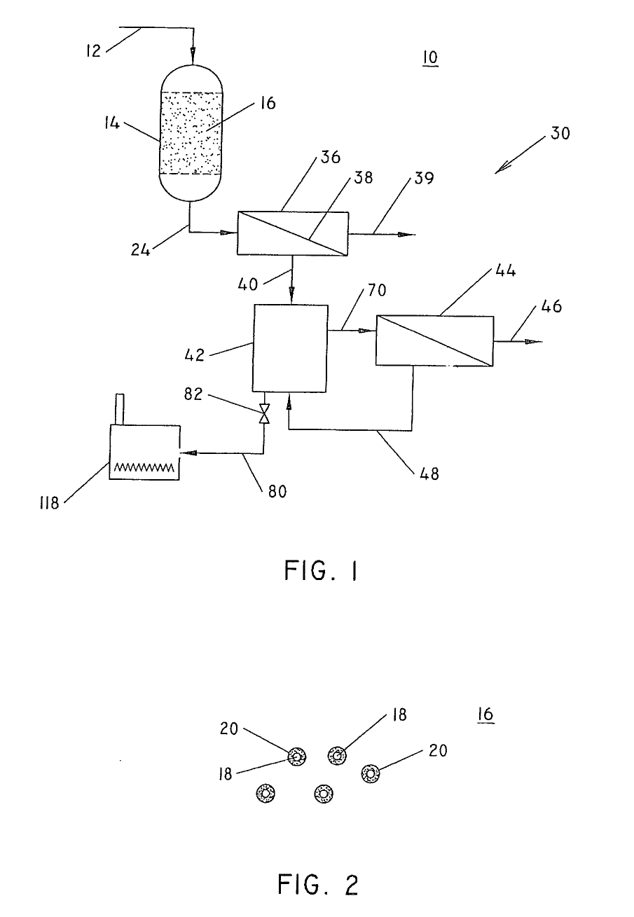

Referring now to the drawings, FIG. 1 illustrates a filtration system 10 for purifying a wastewater stream. The filtration system 10 concentrates dissolved solids in a reject stream so that a substantial portion of the wastewater can be reused. As seen in FIG. 1, an input fluid flow 12 of wastewater containing residual polymer particulate matter and dissolved materials is introduced into a media filtration unit 14. The media filtration unit 14 contains a bed of finely divided filter media particles 16. As shown in FIG. 2, each filter media particle 16 comprises a substrate 18 and an adsorbed layer 20 of a polymer compound such that the compound is adsorbed onto the surface of the filter media substrate 18. The media filtration unit 14 desirably removes substantially all of the particulate matter, but none of the dissolved materials contained in the water.

Suitable filter media are described in commonly assigned U.S. Pat. No. 5,374,357 entitled FILTER MEDIA TREATMENT OF A FLUID FLOW TO REMOVE COLLOIDAL MATTER, which is hereby incorporated by reference in its entirety. Suitable materials for the media particles 16 of the media filtration unit 14 include, but is not limited to 0.2 mm diameter glass beads. The ability of the glass bead media to remove particulate matter is enhanced by the use of a polymer compound 20 which is provided in a form that can adsorb onto the surface of the filter media substrate 18. The preferred polymer compounds 20 are cationic polymers including poly(diallyl-dimethyl ammonium chloride) (DADMAC) type coagulants, such as Magnifloc 591C available commercially from American Cyanamid and as Filtermate 150 available commercially from GE Betz. It is noted that while cationic polymers are preferred, the invention is not to be limited to cationic polymers (e.g. anionic polymers may be used)

The filtrate stream 24 from the media filtration unit 14 is then passed to a staged reverse osmosis (RO) system 30. The filtrate stream 24 is now suitable for removal of dissolved solids using techniques such as reverse osmosis, with substantially reduced likelihood of fouling of the RO system 30. It is desirable that the filtrate stream 24 contains substantially all of the originally dissolved materials but little or no particulate matter to reduce the likelihood of fouling of the RO system 30. The RO system 30 splits the filtrate stream 24 into a concentrate and a permeate containing water that is suitable for reuse as will now be discussed below.

A first stage 36 of the RO system 30 comprises a first reverse osmosis filter 38 designed to concentrate the dissolved materials in the filtrate stream 24 from the media filtration unit 14. The first stage 36 can be of any conventional design known to those skilled in the art of RO systems. Permeate 39 from the first stage can be reused as wash water elsewhere in the manufacturing process. A reject stream 40 from the first stage 36 may be collected in a holding tank 42, or it may be directly introduced into subsequent RO units as feed. Desirably, the system recovery (for example, recovery of a desired dissolvent component such as a surfactant) is between about 70% and 95% and more desirably between about 85% and 90% through the first stage of the RO system 30. The first stage of the RO system 30 achieves about a ten-fold increase in the dissolved solids concentration. There is a corresponding recovery of water as the permeate stream.

The reject stream 40 from the tank (if used) 42 is then processed through a second stage 44 of the RO system 30 via feed line 70. Permeate 46 from this RO can be combined with the permeate from the first RO and reused elsewhere in the manufacturing process. The reject stream 48 from this second RO may be recycled back to a holding tank (if used) 42, or recycled into the feed line of the first RO skid, or subsequently processed through other RO units connected in series or in parallel in a manner known to those skilled in the art of designing and installing RO units. In this way, the concentration of the dissolved solids in the reject stream is ultimately increased over time. In effect, the media filtration unit 14 removes particulate without removing surfactant and thereby enables the RO membrane system 30 to concentrate the surfactant stream while providing a water stream as permeate that can be reused in the manufacturing process.

Desirably, at least 95% of the particles are removed by the filtration unit 14, and more desirably, at least 98% of the particles are removed, and in one preferable embodiment, 100% of the particles are removed. The compound 20 adsorbed onto the substrate surface 18 of the filter media 16 aids in removing the particles so that they are trapped by the filtration unit. Desirably, at least 95% of the dissolved matter passes through the media filtration unit 14 with the filtrate stream 24, more desirably, at least 98% of the dissolved matter pass through the filtration unit, and in one preferable embodiment, 100% of the dissolved matter passes through the filtration unit.

The first stage of the RO system 30 splits the media filter effluent stream into a surfactant bearing concentrate and a permeate. Permeate from the first stage RO unit 36 contains water suitable for reuse. Desirably, the system recovery for this first stage is between about 70% and 95% and more desirably between about 85% and 95% in terms of recovery of dissolved materials relative to the concentration of dissolved materials originally in the wastewater. The reject stream from the first stage may be passed through line 24 and collected in the holding tank 42 or processed through additional RO units as previously described.

Permeate from line 46 may be reused as wash water for the polymerization process. The reject stream from unit 44 may be recycled to the holding tank 42 (if used) or processed directly into subsequent RO units until the reject stream reaches a final desired concentration. When the desired concentration is achieved, the final reject stream is disposed of using conventional thermal or other environmentally acceptable means 118. Alternately, the dissolved materials in the reject stream may be reused in the process. Disposition of the reject stream will depend on the process in question.

The invention is the combination of a specialized media filtration unit with membranes to accomplish particulate separation to subsequently allow surfactant concentration, and water reuse via a membrane system. For example the technology may be generally used to recover and concentrate particulate laden waters containing surfactants (or other dissolved materials) wherein the surfactant (or other material) may either be concentrated for reuse or disposal while providing a means for recovering water for reuse.

One unexpected result from this test (and hence the novelty of the invention over treatment contemplated with the media of aforesaid U.S. Pat. No. 5,374,357) was that the media was very effective in allowing a majority of a negatively charged surfactant to pass through the media column in spite of the fact that the media was coated with a cationic polymer. It is speculated that the interaction of the cationic media polymer with theses anionic surfactants created an intricate web within the filter that facilitated particulate removal. Once the anionic surfactant demand for the cationic polymer was satisfied, all remaining anionic surfactant passed through the column without interacting in any way with the media.

While the disclosure has been illustrated and described in typical embodiments, it is not intended to be limited to the details shown, since various modifications and substitutions can be made without departing in any way from the spirit of the present disclosure. As such, further modifications and equivalents of the disclosure herein disclosed may occur to persons skilled in the art using no more than routine experimentation, and all such modifications and equivalents are believed to be within the scope of the disclosure as defined by the following claims.

What is claimed is:

1. A method of separating particulate matter from a wastewater stream and recovering material such as surfactant dissolved or dispersed in said wastewater stream, said method comprising:
a. admitting said wastewater stream to a media filter containing a polymer sorbed onto the surface of the media such that the media filter captures substantially all of the particulate matter while passing effluent containing a desired dissolved or dispersed material, and
b. forwarding the effluent from the media filter to a plurality of membranes arranged in such a way to create multiple permeate streams, each suitable for reuse in the manufacturing process, and at least one reject stream, including a final reject containing said material concentrated for reuse or destruction.

2. A method as recited in claim 1 wherein said media filter comprises a multiplicity of particles coated with a polymer.

3. A method as recited in claim 2 wherein said coating polymer comprises a cationic polymer.

4. A method as recited in claim 3 wherein said waste stream is a stream from a polymerization process produced during polymer manufacture (e.g., in the case of plastics; thermosetting resins, thermoplastic resins, polymer resins (e.g., polyethers, polyethylene, polyvinyl or polyvinyldifluoride), oil soluble or modified resins).

5. A method as recited in claim 4 wherein said material includes surfactant having an anionic moiety.

6. A method as recited in claim 3 wherein said wastewater stream is a wash stream from manufacture of a polymer and said particulate matter comprises particles of said polymer which are captured by the media filter.

7. A method as recited in claim 6 wherein said particles have a broad size distribution that would clog, foul, or reduce flux of a direct membrane filtration process.

8. A method as recited in claim 1 wherein said wastewater stream is processed in a batch process.

9. A method as recited in claim 1 wherein said plurality of membranes are arranged as a staged system for concentrating the desired dissolved or dispersed material, and/or as a multipass system for enhanced recovery of water.

10. A method as recited in claim 1 wherein said final reject is forwarded to a disposal operation (e.g., thermal district).

11. A method for the purifying and recovering of wash water created during the manufacturing process of a polymer, said method comprising:
providing a media filtration unit having filter media particles which comprise a substrate and an adsorbed layer of a polymer compound adsorbed onto substrate;
introducing an input fluid flow of wash water containing particles of polymer and dissolved undesirable moieties (e.g., surfactants) into the media filtration unit so that substantially all of the polymer particles are removed by the media filtration unit and substantially all of the dissolved undesirable moieties (e.g., surfactants) remain in the filtrate stream of the media filtration unit;
introducing the filtrate stream to a plurality of reverse osmosis (RO) units wherein the RO system splits the stream into a surfactant bearing concentrate and a permeate;
collecting the permeates for reuse as wash or other process water;
collecting the rejects streams from a final stage of said RO units; and
disposing of the final reject stream.
